(19) United States
(12) Patent Application Publication
(10) Pub. No.: US 2025/0129649 A1
(43) Pub. Date: Apr. 24, 2025

(54) ADJUSTABLE HINGE

(71) Applicant: Charles A. Noble, III, North Berwick, ME (US)

(72) Inventor: Charles A. Noble, III, North Berwick, ME (US)

(21) Appl. No.: 18/913,032

(22) Filed: Oct. 11, 2024

Related U.S. Application Data
(60) Provisional application No. 63/545,394, filed on Oct. 24, 2023.

(51) Int. Cl. E05D 7/04; E05D 3/02

(52) U.S. Cl. CPC E05D 7/0415; E05D 3/02

(57) ABSTRACT

An adjustable hinge is disclosed. The adjustable hinge includes a door jamb or frame leaf hinge plate and a door leaf hinge plate. The adjustable hinge includes at least one height adjustment spacer configured to a move a position of the door leaf hinge plate relative to the jamb hinge plate. The jamb or frame leaf incudes a set of holes for receiving spacers or shim buttons for adjusting a spacing of the jamb or frame leaf hinge plate relative to the door jamb. The door leaf hinge plate includes slots for receiving mounting hardware for adjusting a position of the door leaf hinge plate relative to the door's edge.

### BACKGROUND

The clearance allowance for a fire door assembly is stringent so as to meet the standard for passing fire door assembly tests. The clearance allowed is only ⅛″ between the door and its frame, top and vertical edges and ¾″ for the undercut below the door. The test for fire door assemblies is the NFPA-252 (originally known as the UL-10B/C). When the door is closed and is resting against the frame's door stop, the clearance has to be ⅛″ or less from the pull side of the door, ⅛″ between the door and its frame, top and vertical edges of the frame and ¾″ below the door and the floor. The NFPA-252 test has taught us that if the clearance is larger than ⅛″, fire and hot gases pass through the clearance and erode the door, and the fire comes through the gap to the other side of the door. Per the standards, fire cannot pass through the clearances to the other side of the door. Such a condition results in an NFPA-252 test failure. When running a test on a fire door assembly, the fire door itself is mounted perfectly in the frame so as to avoid any such clearance gaps, and it must be to pass the test. This is the way all doors, frames, and hardware are tested, whether they are fire doors or smoke doors or standard non-rated door assemblies.

However, this is not the reality of a door assembly when installed in the real world. Installing any door assembly comes with real challenges in the built world. In is not unusual for the walls to be out of plumb, for the frame to not be squared and for the header to not be level. However, the door itself was manufactured in a factory in ideal conditions and manufactured perfectly square. The perfectly squared door when installed in the field, typically cannot meet the required clearances/gaps with such an inconsistent frame installation, and this being in a fire condition, the door will not be able to hold back the fire as assumed by the underwriter's certification label on the assemblies door, frame or hardware (lock) which assumes that all products in a fire door assembly are installed exactly to their “manufacturers' installation instructions”, which is perfect, just as tested. If not, it voids all warranties and is non-compliant with national and state and local fire codes.

The same is true for smoke rated doors and regular pass through doors. They all need to have the door seat perfectly against the door frames for all the clearances, hardware and seals to work as they all are intended and tested whether they are on a fire door assembly or not. However, installing a passage door in a building often requires the installer to adjust the position of the door with respect to the frame. Any slight distortions in the door, or the door frame will require that the door be adjusted to meet the clearance requirements and so that the latch and sealing functions of the door perform smoothly as required by all the manufacturers' and by their manufacturer's installation instruction.

There are four major components that make up a door assembly. (1) The door, (2) the frame (which is also called the jamb), (3) the hinges, (4) and the lock. Thus, there is a need for means for adjustment to these products to adjust for such issues. Currently, there is not an easy or efficient way to adjust the door to its frame. The only solution is often to either replace the door, reinstall the frame, or even correct the wall. Another remedy that has been developed for fire rated doors accessories so as to remedy the clearance issues. However, these accessories add additional cost, can be hard to install in the field, and require maintenance, and are becoming very expensive to install.

Accordingly, there is needed for a mechanism that enables adjustment of the door with its door frame.

### SUMMARY OF INVENTION

Aspects and embodiments are directed to an easy solution to correct the door and frame clearance issues.

Aspects and embodiments are directed to an adjustable door hinge that can simply adjust any or all of plumb adjustments, square adjustments and leveling adjustments. Aspects and embodiments are directed to an adjustable door hinge that can adjust any or all of plumbness of the door, squareness of the door, and/or level of the door with respect to the door frame.

Aspects and embodiments are directed to an adjustable hinge that has three adjustable components to allow for many different types and combinations of adjustments, all with one hinge. In one embodiment, three components include: a frame leaf of the hinge that has adjustment buttons to adjust for movement of the door left to right to close or open the clearance, and also to adjust the door to close parallel to the frame removing any hinge binding issues; a door leaf of the hinge has slotted screw holes that allows for adjustment of the door to be moved in and out against the frame when the wall is not plumb; and a locking pin or pin bearing barrel has adjustable bearings that allow the door to be moved up or down.

Aspects and embodiments are directed to an adjustable hinge for adjusting the height of a door. The adjustable hinge includes a door jamb or frame leaf hinge plate to be mounted to a door frame/door jamb and a door leaf hinge plate to be mounted to a vertical side of a door. The adjustable hinge includes at least one height adjustment spacer configured to a move a position of the door leaf hinge plate relative to the jamb hinge plate about a vertical axis of a locking pin or pin bearing of the adjustable hinge. With this arrangement a height of a door with respect to the door jamb can be adjusted.

Aspects and embodiments are directed to an adjustable hinge for a door having a jamb or frame leaf hinge plate to be mounted to a door frame/door jamb and a second door leaf hinge plate to be mounted to a vertical side of a door. The jamb or frame leaf includes a set of holes in the jamb or frame leaf hinge plate for receiving spacers or shim buttons for adjusting a spacing of the jamb or frame leaf hinge plate relative to the door jamb. With this arrangement a squareness of the door with respect to the door jamb so it can be adjusted.

Aspects and embodiments are directed to an adjustable hinge for a door including a jamb or frame leaf hinge plate to be mounted to a doors' frame and its door jamb and a door leaf hinge plate to be mounted to the vertical side of a door. The door leaf hinge plate includes slots for receiving mounting hardware for adjusting a position of the door leaf hinge plate relative to the door's edge. With this arrangement a flushness of the door with respect to the door jamb can be adjusted.

Aspects and embodiments are directed to an adjustable hinge for a door frame having a frame leaf hinge plate to be mounted to the frame and a second door leaf hinge plate to be mounted to a vertical side of a door itself. The jamb or frame leaf includes a set of holes in the frame leaf hinge plate for receiving spacers or shim buttons for adjusting a spacing of the frame leaf hinge plate relative to the door frame. The door leaf hinge plate includes slots for receiving mounting hardware for adjusting a position of the door leaf hinge plate relative to the door's edge for adjusting a flushness of the door with respect to the door jamb. There is at least one heigh adjustment spacer configured to a move a position of the door leaf hinge plate relative to the jamb hinge plate about a vertical axis of a locking pin or pin bearing of the adjustable hinge. With this arrangement, any of a height of a door, a squareness of the door with respect to the door jamb, and a flushness of the door with respect to the door jamb can be adjusted.

Aspects and embodiments are directed to an adjustable hinge for a door having a first hinge plate or jamb or frame leaf to be mounted to a door frame/door jamb and a second hinge plate or door leaf to be mounted to a vertical side of a door. Hinge knuckles of the first and second hinge plates and a locking pin or pin bearing pivotally connect the two hinge plates together. There are a first set of holes in the jamb hinge plate for receiving mounting hardware for mounting the hinge to a door frame. There are a second set of holes in the jamb or frame leaf hinge plate for receiving spacers or shim buttons and adjusting the spacing of the jamb or frame leaf hinge plate relative to the door jamb. The door leaf hinge plate has slots for receiving mounting hardware for adjusting a position of the door relative to the door's edge for adjusting a flushness of the door with respect to the door jamb. There is at least one heigh adjustment spacer configured to a move a position of the door leaf hinge plate relative to the jamb hinge plate about a vertical axis of the locking pin or pin bearing. With this arrangement, any of a height of a door, a squareness of the door with respect to the door jamb, and a flushness of the door with respect to the door jamb can be adjusted.

Aspects and embodiments are directed to an adjustable hinge for a door having a jamb or frame leaf to be mounted to a door frame/door jamb and a door leaf to be mounted to a vertical side of a door. The jamb or frame leaf and the door leaf each having at least one leaf knuckle configured to receive a pin and thrust bearings that together form a pin connection so as to fix the door leaf and jamb or frame leaf against relative axial movement and to enable the door leaf and jamb or frame leaf to rotate relative to each other about a pivot axis of the pin connection. The jamb or frame leaf having first hole patterns for receiving first attachment parts for mounting the jamb or frame leaf to a door jamb. The jamb or frame leaf having second hole patterns configured for receiving jamb or frame leaf spacers or shim buttons for adjusting a relative squareness position of the jamb or frame leaf with respect to door jamb so as to adjust the jamb or frame leaf squareness inward or outward from the door jamb. The door leaf having slots in the door leaf configured for receiving second attachment parts for mounting the door leaf to an edge of the door, and for enabling moving of the door along the slots so to adjust a position of the door relative to the door leaf so as to adjust a plumbness of the door with respect to jamb or frame leaf. The adjustable hinge further comprising height adjustment spacers configured to be disposed about the pin and between at least one knuckle of the door leaf and at least one knuckle of the jamb or frame leaf so as to raise or lower a relative height of the door leaf with respect to the jamb or frame leaf. With this arrangement, any of a height of a door, a squareness of the door with respect to the door jamb, and a flushness of the door with respect to the door jamb can be adjusted.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Aspects and embodiments are directed to an easy solution to correct the door and frame clearance issues. Aspects and embodiments are directed to an adjustable door hinge that can adjust any or all of plumb adjustment, square adjustment and leveling adjustment. Aspects and embodiments are directed to an adjustable door hinge that can adjust any or all of plumbness of the door, squareness of the door, and/or level of the door with respect to the door frame.

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral or number. For purposes of clarity, not every component may be labeled in every figure.

Various aspects of at least one embodiment are discussed below with reference to the accompanying figures. The figures are provided for the purposes of illustration and explanation and are not intended as a definition of the limits of the invention.

In the figures:

FIG. 1 is a view of an adjustable hinge with a door leaf in a first position with respect to a jamb or frame leaf according to an embodiment of the disclosure;

FIG. 2 is a view of the adjustable hinge of FIG. 1 with the door leaf in a second position with respect to a jamb or frame leaf according to an embodiment of the disclosure;

FIG. 3 is a view of the adjustable hinge of FIG. 1 with the door leaf in a second position with respect to a jamb or frame leaf according to an embodiment of the disclosure;

FIG. 4 is an exploded view of the adjustable hinge of FIG. 1 illustrating height adjustment spacers according to an embodiment of the disclosure;

FIG. 5 is a view of an adjustable hinge with a jamb or frame leaf configured in a first position (into) with respect to a door jamb according to an embodiment of the disclosure;

FIG. 6 is a view of an adjustable hinge with a jamb or frame leaf configured in a second position (out of) with respect to a door jamb according to an embodiment of the disclosure;

FIG. 7 is a view of an adjustable hinge with a jamb or frame leaf configured in a third position (flush) with respect to a door jamb according to an embodiment of the disclosure;

FIG. 8 is a view of an adjustable hinge with a door leaf configured in a first position (flush) with respect to an edge of door according to an embodiment of the disclosure; and

FIG. 9 is a view of an adjustable hinge with a door leaf configured in a second position (not flush) with respect to an edge of door according to an embodiment of the disclosure;

FIG. 10 is a detailed view of an embodiment of an adjustable hinge according to an embodiment of the disclosure.

### DETAILED DESCRIPTION

### LIST OF REFERENCE NUMERALS UTILIZED IN THE DRAWINGS

With regard to reference numerals or numbers used, the following numbering is used throughout the description and drawings. Where technical features in the figures or detailed description are followed by these reference numerals or numbers, the reference numerals or numbers have been included for the sole purpose of increasing the intelligibility of the figures or detailed description. Accordingly, neither the reference numerals or numbers nor their absence is intended to have any limiting effect on the scope of any claim elements. In the figures, each identical or nearly identical component that is illustrated in various figures is represented by a like numerals or number. For purposes of clarity, not every component may be labeled in every figure.
Reference number 10 refers to Adjustable Hinge.
Reference number 12 refers to a Jamb or frame leaf.
Reference number 14 refers to Door Leaf.
Reference number 16 refers to a Locking pin or pin bearing 16.
Reference number 18 refers to Leaf Knuckles.
Reference number 20 refers to Roller Thrust Bearings.
Reference number 22 refers to a Pivot Axis of the adjustable Hinge.
Reference number 24 refers to the standard Hole Pattern for securing the Jamb or frame leaf with fasteners to a door jamb.
Reference number 26 refers to Adjustment Squareness Holes in the Jamb or frame leaf.
Reference number 28 refers to Spacers or Shim Buttons used with Adjustment Squareness Holes.
Reference number 30 refers to Elongated Slots in the Door Leaf for Door Flushness Adjustment.
Reference number 32 refers to removable Height Adjustment Spacers.
Reference number 34 refers to a door jamb.
Reference number 36 refers to a reinforced backing plate.
Reference number 38 refers to a door.
Reference number 40 refers generally to fasteners.

Aspects and embodiments are directed to an easy solution to correct door and frame clearance issues. Aspects and embodiments are directed to an adjustable door hinge that can adjust any or all of plumb adjustment, square adjustment and leveling adjustment. Aspects and embodiments are directed to an adjustable door hinge that can adjust any or all of plumbness of the door, squareness of the door, and/or level of the door with respect to the door frame.

Aspects and embodiments are directed to an adjustable hinge for adjusting the height of a door. The adjustable hinge includes a door jamb or frame leaf hinge plate to be mounted to a door frame/door jamb and a door leaf hinge plate to be mounted to a vertical side of a door. The adjustable hinge includes at least one height adjustment spacer configured to a move a position of the door leaf hinge plate relative to the jamb hinge plate about a vertical axis of a locking pin or pin bearing of the adjustable hinge. With this arrangement a height of a door with respect to the door jamb can be adjusted.

Aspects and embodiments are directed to an adjustable hinge for a door having a jamb or frame leaf hinge plate to be mounted to a door frame/door jamb and a door leaf hinge plate to be mounted to a vertical side of a door. The jamb or frame leaf incudes a set of holes in the jamb or frame leaf hinge plate for receiving spacers or shim buttons for adjusting a spacing of the jamb or frame leaf hinge plate relative to the door jamb. With this arrangement a squareness of the door with respect to the door jamb can be adjusted.

Aspects and embodiments are directed to an adjustable hinge for a door including a jamb or frame leaf hinge plate to be mounted to a door frame/door jamb and a door leaf hinge plate to be mounted to a vertical side of a door. The door leaf hinge plate includes slots for receiving mounting hardware for adjusting a position of the door leaf hinge plate relative to the door's edge. With this arrangement a flushness of the door with respect to the door jamb can be adjusted.

Aspects and embodiments are directed to an adjustable hinge for adjusting a height of a door. The adjustable hinge includes a door jamb or frame leaf hinge plate to be mounted to a door frame/door jamb and a door leaf hinge plate to be mounted to a vertical side of a door. The adjustable hinge includes at least one height adjustment spacer configured to a move a position of the door leaf hinge plate relative to the jamb hinge plate about a vertical axis of a locking pin or pin bearing of the adjustable hinge. The jamb or frame leaf incudes a set of holes in the jamb or frame leaf hinge plate for receiving spacers or shim buttons for adjusting a spacing of the jamb or frame leaf hinge plate relative to the door jamb. With this arrangement any of a height of a door and a squareness of the door with respect to the door jamb can be adjusted.

Aspects and embodiments are directed to an adjustable hinge for adjusting a height of a door. The adjustable hinge includes a door jamb or frame leaf hinge plate to be mounted to a door frame/door jamb and a door leaf hinge plate to be mounted to a vertical side of a door. The adjustable hinge includes at least one height adjustment spacer configured to a move a position of the door leaf hinge plate relative to the jamb hinge plate about a vertical axis of a locking pin or pin bearing of the adjustable hinge. The door leaf hinge plate includes slots for receiving mounting hardware for adjusting a position of the door leaf hinge plate relative to the door's edge. With this arrangement a height of a door with respect and a flushness of the door with respect to the door jamb can be adjusted.

Aspects and embodiments are directed to an adjustable hinge for a door having a jamb or frame leaf hinge plate to be mounted to a door frame/door jamb and a door leaf hinge plate to be mounted to a vertical side of a door. The jamb or frame leaf incudes a set of holes in the jamb or frame leaf hinge plate for receiving spacers or shim buttons for adjusting a spacing of the jamb or frame leaf hinge plate relative to the door jamb. The door leaf hinge plate includes slots for receiving mounting hardware for adjusting a position of the door leaf hinge plate relative to the door's edge. With this arrangement a squareness of the door and a flushness of the door with respect to the door jamb can be adjusted.

Aspects and embodiments are directed to an adjustable hinge for a door having a jamb or frame leaf hinge plate to be mounted to a door frame/door jamb and a door leaf hinge plate to be mounted to a vertical side of a door. The jamb or frame leaf incudes a set of holes in the jamb or frame leaf hinge plate for receiving spacers or shim buttons for adjusting a spacing of the jamb or frame leaf hinge plate relative to the door jamb. The door leaf hinge plate includes slots for receiving mounting hardware for adjusting a position of the door leaf hinge plate relative to the door's edge for adjusting a flushness of the door with respect to the door jamb. There is also provided at least one height adjustment spacer configured to be mounted about a locking pin or pin bearing between at least one leaf knuckle of the door leaf and jamb or frame leaf to a move a position of the door leaf hinge plate relative to the jamb hinge plate about a vertical axis of the locking pin or pin bearing. With this arrangement, any of a height of a door, a squareness of the door with respect to the door jamb, and a flushness of the door with respect to the door jamb can be adjusted.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

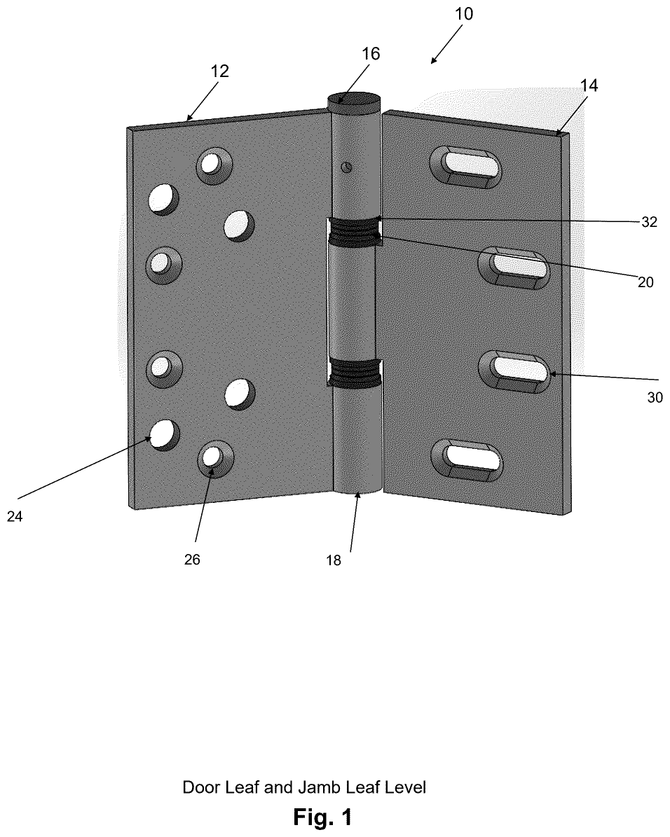

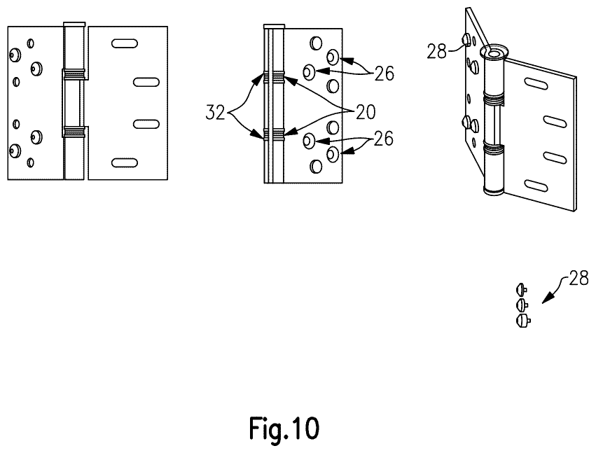

Referring to FIGS. 1-3, there is illustrated an embodiment of an adjustable hinge 10. The adjustable hinge 10 allows for a solid mount against a frame of a door, and adjustable mounting of the door within a door frame. The adjustable hinge has two leafs: a Jamb or frame leaf 12 with a standardized door hinge fastener hole pattern 24, adjustment squareness holes 26 to accommodate adjustment spacers or shim buttons 28 (See FIG. 10), and a door leaf 14 configured with slots 30 to allow for door position adjustment. The two hinge leafs are held together with a locking pin or pin bearing 16 received by at least one hinge knuckle 18. A height between the two hinge leafs can be adjusted by removable height adjustment spacers 32. The adjustable hinge operates smoothly and pivots about a vertical hinge point with roller thrust bearings 20. This adjustable hinge is designed to accommodate imperfect field conditions in which a door may not sit correctly within the jamb. The adjustable hinge allows for any of door level, plumb, and square adjustments. In particular, the adjustable hinge provides for adjustment of any of vertical hinge adjustment, hinge squareness adjustment, and door flushness adjustment.

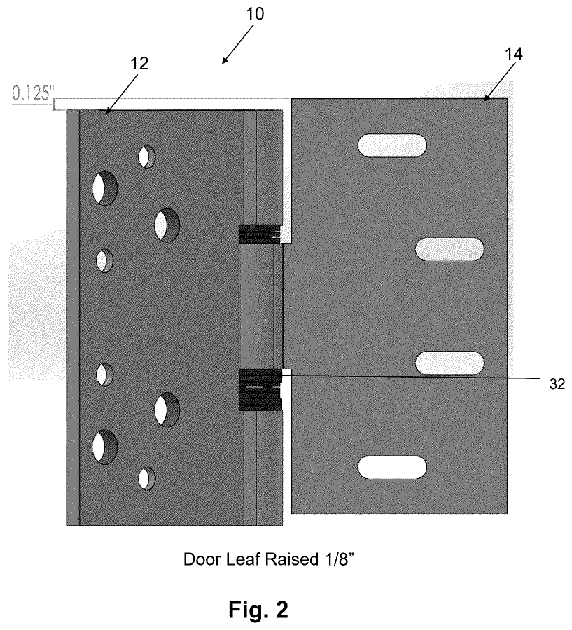

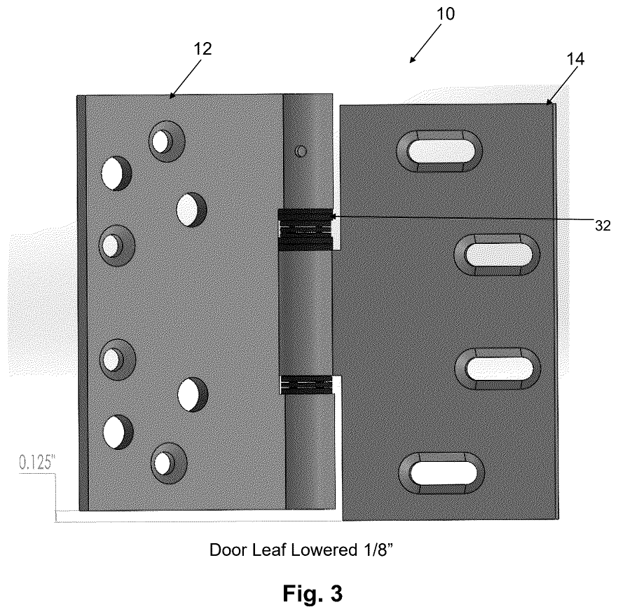

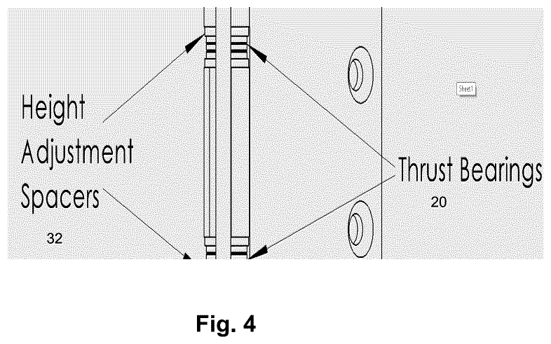

Referring to FIGS. 1-4, there is illustrated a height adjustment aspect of one embodiment of an adjustable hinge 10. Thrust bearings 20, shown in Red, normally take the weight of the door and allow for smooth operation. Vertical adjustment (VA) is achieved through use of removable height spacers 32, which can be relocated in between at least one knuckle of each leaf of the adjustable hinge in order to yield a desired vertical adjustment. These spacers can be used to move the door leaf up or down in relation to the jamb or frame leaf. The height adjustable spacers 32 are shown in Blue. These spacers may be arranged in several arrangements, and can be made in various thickness in order to accommodate varying door height adjustments in relation to the door jamb. As illustrated in FIGS. 1-4, for example using 1/16″ thick spacers. The thrust bearings do not move with the changes in the removable height spacers 32. It is appreciated that the jamb or frame leaf 12 of the adjustable hinge stays fixed to the door jamb and does not move up or down, while the door leaf and door can be configured to be level with respect to the jamb as illustrated in FIG. 1, to raise the door leaf 14 and door with respect to the jamb or frame leaf 12 as illustrated in FIG. 2, or to lower the door leaf 14 and door with respect to the jamb or frame leaf 12 as illustrated in FIG. 3.

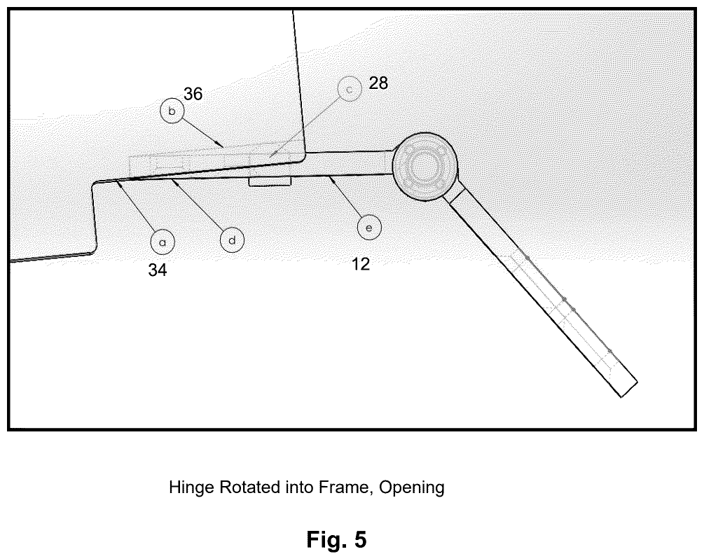

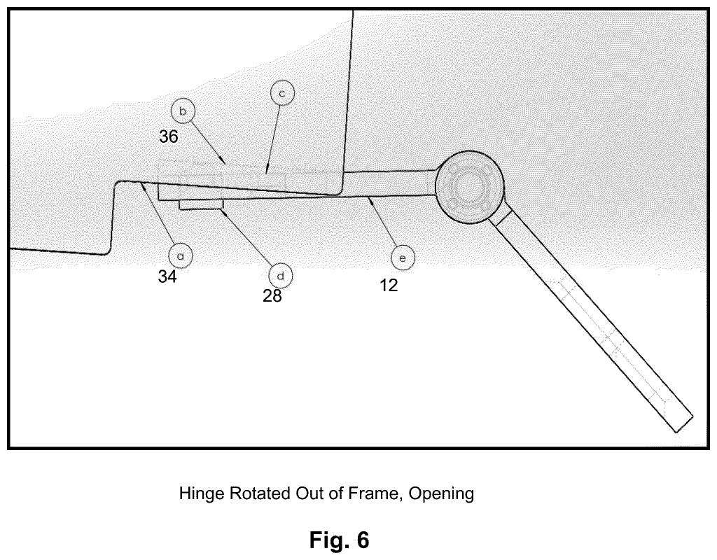

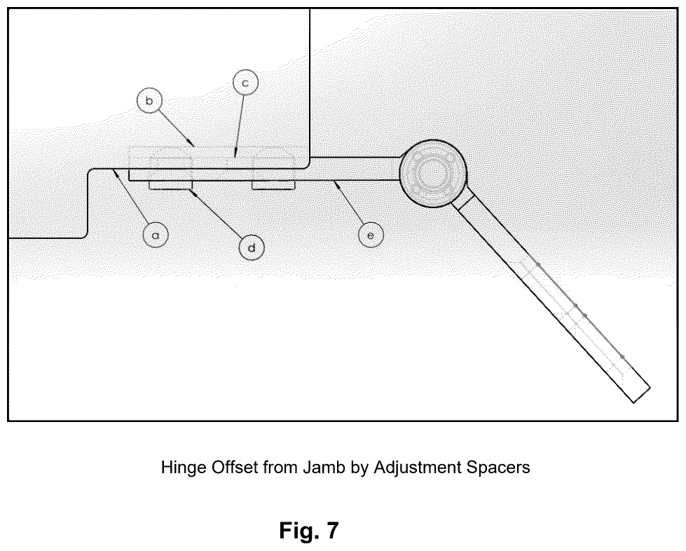

Referring to FIGS. 5-7, there is illustrated a hinge squareness adjustment aspect of one embodiment of an adjustable hinge 10. The adjustable hinge is equipped with, for example, four adjustable squareness (AS) holes 26 (highlighted in green) disposed in the jamb or frame leaf 12. The squareness of the hinge with respect to the door jamb 34 is adjusted by use of one or more spacers or shim buttons 28 (See FIG. 10), which provide for adjustment of squareness of the jamb or frame leaf and the hinge, if the jamb is not square. The spacers or shim buttons press against a reinforced backing plate 36 in the steel frame hinge mortise, and adjust to move the hinge jamb or frame leaf in a variety of ways as illustrated in FIGS. 5-6: the jamb or frame leaf rotated into the frame as illustrated in FIG. 5, and the jamb or frame leaf rotated out of the frame as illustrated in FIG. 6, The hinge jamb or frame leaf can also be moved outwards, moving the door away from the jamb if necessary, by inserting all four adjustment spacers or shim buttons so as to offset the jamb or frame leaf from the door jamb as illustrated in FIG. 7. It is appreciated that the spacers or shim buttons can be removed for a typical frame-to-hinge interface.

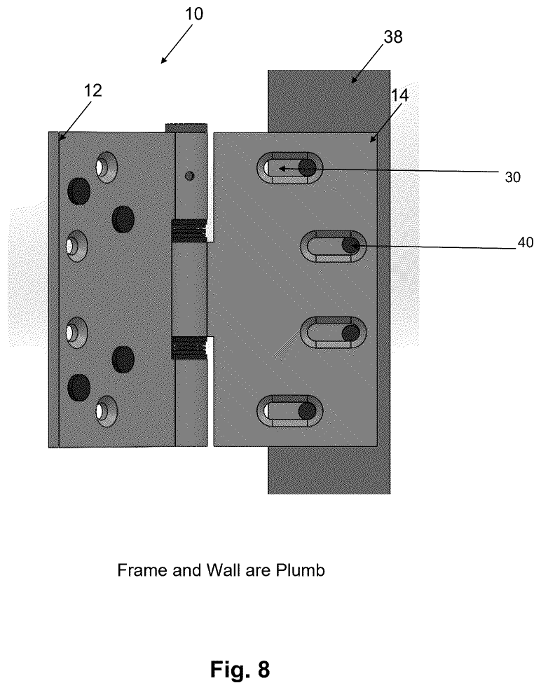

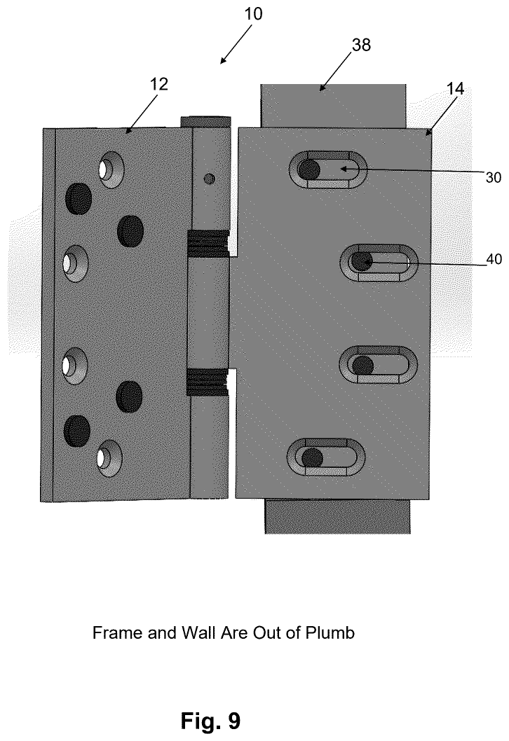

Referring to FIGS. 8-9, there is illustrated a door flushness adjustment aspect of an embodiment of an adjustable hinge 10. A Plumb Line (PL) is the alignment of the locking pin or pin bearing 16 on a single axis in reference to the frame of the door. A proper adjusted PL allows the door to swing freely, close properly, and eliminates binding of the hinges. According to aspects and embodiments, the door leaf 14 may include elongated adjustment slots 30 for aligning the door plumb line in the door frame. These slots and associated mounting fasteners 40 provide for seating the door flush against the door frame, thereby providing for abnormalities in the construction of the door frame and surrounding wall.

FIG. 8 shows a door with plumb that is flush. The door is parallel to the axis of rotation created by the locking pin or pin bearing 16. FIG. 9 illustrates a door that is out of plumb, where the door frame and wall have shifted or was improperly installed out of plumb. FIG. 9 illustrates a door which has been adjusted to account for this common field condition by adjusting a position of the door along the elongated slots 30 with respect to the door jamb with the plumb line adjustment feature. Please note that the type of hinge screws or fasteners 40 have been omitted for the Figures for clarity.

FIG. 10 shows the hinge assembly including different sized shim buttons 28 that can be used with the adjustable hinge assembly. An aspect is that the adjustable hinge is configured to adjust the door (connected to the hinge assembly) placement to push or pull the door side to side, within the door frame, via the use of the shim buttons, thereby relieving pressure on the hinge from being bound within the door and frame. An aspect is that the adjustable hinge is configured to adjust the door (connected to the hinge assembly) placement when the wall is not plumb and causes the door to not sit properly against the door frame by aligning the hinge pins. An aspect is that the adjustable hinge is configured so that hinge pin and the door (connected to the hinge assembly) can be raised or lowered.

It is appreciated that the hinge assembly can be made of Ferrous and/or non-Ferrous materials. It is appreciated that although the hinge is illustrated having a height dimension of 4.5″, the hinge can be made with any industry standard dimensions, as well as other customized dimensions. It is appreciated that the pin bearing can be of different sizes and different materials.

It is appreciated that the hinge assembly is designed to push or pull the door side to side within the frame with the shim buttons, and to relieve pressure on the door hinge from being bound within the door and frame (Hinge Bound). It is appreciated that the hinge assembly is designed to adjust the door properly by aligning the hinge pins when the wall is not plumb that causes the door to not sit properly against its frame when the door is in the closed position. It is appreciated that the hinge assembly is designed to raise or lower the door within the frame.

According to aspects and embodiments of the adjustable hinge, when the door frame is not plumb because the wall is not plumb, one can adjust with adjustable hinge with the adjustable hinge leaf, by pushing or pulling the door in and out seating the door against the frame's door stop. When the door frame is not plumb one can adjust the Adjustable Hinge with an adjustable shimming button, on the frame side leaf and push the door side-ways and correct the plumb issue, so the door seats properly against its door stop. When the door frame is not plumb one can adjust the Adjustable Hinge on the hinge with the adjustable shimming button to alleviate any hinge bound issue with the door seating the door properly with the hinge side frame. When the door frame is not plumb one adjust the Adjustable Hinge to open a tight clearance on the hinge side with the Adjustable Shimming Button and close the clearance on the lock side.

According to aspects and embodiments of the adjustable hinge, when the door is installed and the there is a clearance issue on the top (Horizontal Door Frame), because the hinge locations on the door were set too low or too high, one can raise or lower the door leaf jamb and door by moving and relocating the adjustable height adjustment spacers (bearings) on the locking pin or pin bearing between the knuckler of the door leaf and jamb or frame leaf to move the door leaf and door, either up or down. According to aspects and embodiments, when the frame is installed out of square and the door is not squared to the frame, creating an excessive clearance on the lock side of the door only, one can adjust the Adjustable Hinge by raising the door by relocating the adjustable spacers on the pin as discussed above therefore closing any gap clearance. According to aspects and embodiments, when the door is installed and the frame is not square, the locking hardware may not work because the lock was designed for a squared door and frame. With the adjustable hinge arrangement, one can adjust the door with the by using one or all the adjustments herein disclosed mechanisms to square the door's lock locations to the lock's striker plate on the frame side.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. An adjustable hinge (10), comprising:
a jamb or frame leaf (12) including first holes (24) for receiving first fastening parts for mounting the jamb or frame leaf to a door jamb;
a door leaf (14) for mounting the adjustable hinge to a door;
the jamb or frame leaf and the door leaf each having at least one door leaf knuckle (18) configured to receive a locking pin or pin bearing (16) and roller thrust bearings (20) that form a pin connection so as to fix the door leaf and jamb or frame leaf against relative axial movement and to enable the door leaf and jamb or frame leaf to rotate relative to each other about a pivot axis (22) of the locking pin or pin bearing and at least one leaf knuckle connection;
(C) squareness adjustment holes (26) in the jamb or frame leaf configured to receive jamb or frame leaf spacers or shim buttons (28) for adjusting a relative position of the jamb or frame leaf inward or outward with respect to door jamb so as to adjust the jamb or frame leaf squareness with the door jamb and independently of the pivot connection;
(B) elongated slots (30) in the door leaf configured for receiving second fastener parts for attaching the door leaf to an edge of the door and for moving the door along the elongated slots to adjust a flushness position of the door relative to the jamb or frame leaf and independently of the pivot connection; and
(A) height adjustment spacers (32) configured to be disposed about the locking pin or pin bearing between at the least one knuckle of the door leaf and the at least one knuckle of the jamb or frame leaf so as to raise or lower a relative height of the door leaf with respect to the jamb or frame leaf.

2. An adjustable hinge (10), comprising:
a jamb or frame leaf (12) including first holes (24) for receiving first fastening parts for mounting the jamb or frame leaf to a door jamb;
a door leaf (14) for mounting the adjustable hinge to a door;
the jamb or frame leaf and the door leaf each having at least one door leaf knuckle (18) configured to receive a locking pin or pin bearing (16) and roller thrust bearings (20) that form a pin connection so as to fix the door leaf and jamb or frame leaf against relative axial movement and to enable the door leaf and jamb or frame leaf to rotate relative to each other about a pivot axis (22) of the locking pin or pin bearing and at least one leaf knuckle connection;
(B) elongated slots (30) in the door leaf configured for receiving second fastener parts for attaching the door leaf to an edge of the door and for moving the door along the elongated slots to adjust a flushness position of the door relative to the jamb or frame leaf and independently of the pivot connection; and
(A) height adjustment spacers (32) configured to be disposed about the locking pin or pin bearing between at the least one knuckle of the door leaf and the at least one knuckle of the jamb or frame leaf so as to raise or lower a relative height of the door leaf with respect to the jamb or frame leaf.

3. The Adjustable hinge (10) of claim 2, further comprising (C) squareness adjustment holes (26) in the jamb or frame leaf configured to receive jamb or frame leaf spacers or shim buttons (28) for adjusting a relative position of the jamb or frame leaf inward or outward with respect to door jamb so as to adjust the jamb or frame leaf squareness with the door jamb and independently of the pivot connection.

4. An adjustable hinge (10), comprising:
a jamb or frame leaf (12) including first holes (24) for receiving first fastening parts for mounting the jamb or frame leaf to a door jamb;
a door leaf (14) for mounting the adjustable hinge to a door;
the jamb or frame leaf and the door leaf each having at least one door leaf knuckle (18) configured to receive a locking pin or pin bearing (16) and roller thrust bearings (20) that form a pin connection so as to fix the door leaf and jamb or frame leaf against relative axial movement and to enable the door leaf and jamb or frame leaf to rotate relative to each other about a pivot axis (22) of the locking pin or pin bearing and at least one leaf knuckle connection;
(C) squareness adjustment holes (26) in the jamb or frame leaf configured to receive jamb or frame leaf spacers or shim buttons (28) for adjusting a relative position of the jamb or frame leaf inward or outward with respect to door jamb so as to adjust the jamb or frame leaf squareness with the door jamb and independently of the pivot connection; and
(A) height adjustment spacers (32) configured to be disposed about the locking pin or pin bearing between at the least one knuckle of the door leaf and the at least one knuckle of the jamb or frame leaf so as to raise or lower a relative height of the door leaf with respect to the jamb or frame leaf.

5. The Adjustable hinge (10) of claim 4, further comprising (B) elongated slots (30) in the door leaf configured for receiving second fastener parts for attaching the door leaf to an edge of the door and for moving the door along the elongated slots to adjust a flushness position of the door relative to the jamb or frame leaf and independently of the pivot connection.

6. An adjustable hinge (10), comprising:
a jamb or frame leaf (12) including first holes (24) for receiving first fastening parts for mounting the jamb or frame leaf to a door jamb;
a door leaf (14) for mounting the adjustable hinge to a door;
the jamb or frame leaf and the door leaf each having at least one door leaf knuckle (18) configured to receive a locking pin or pin bearing (16) and roller thrust bearings (20) that form a pin connection so as to fix the door leaf and jamb or frame leaf against relative axial movement and to enable the door leaf and jamb or frame leaf to rotate relative to each other about a pivot axis (22) of the locking pin or pin bearing and at least one leaf knuckle connection;
(C) squareness adjustment holes (26) in the jamb or frame leaf configured to receive jamb or frame leaf spacers or shim buttons (28) for adjusting a relative position of the jamb or frame leaf inward or outward with respect to door jamb so as to adjust the jamb or frame leaf squareness with the door jamb and independently of the pivot connection; and
(B) elongated slots (30) in the door leaf configured for receiving second fastener parts for attaching the door leaf to an edge of the door and for moving the door along the elongated slots to adjust a flushness position of the door relative to the jamb or frame leaf and independently of the pivot connection.

7. The Adjustable hinge (10) of claim 6, further comprising (A) height adjustment spacers (32) configured to be disposed about the locking pin or pin bearing between at the least one knuckle of the door leaf and the at least one knuckle of the jamb or frame leaf so as to raise or lower a relative height of the door leaf with respect to the jamb or frame leaf.

8. An adjustable hinge (10), comprising:
a jamb or frame leaf (12) including first holes (24) for receiving first fastening parts for mounting the jamb or frame leaf to a door jamb;
a door leaf (14) for mounting the adjustable hinge to a door;
the jamb or frame leaf and the door leaf each having at least one door leaf knuckle (18) configured to receive a locking pin or pin bearing (16) and roller thrust bearings (20) that form a pin connection so as to fix the door leaf and jamb or frame leaf against relative axial movement and to enable the door leaf and jamb or frame leaf to rotate relative to each other about a pivot axis (22) of the locking pin or pin bearing and at least one leaf knuckle connection; and
(A) height adjustment spacers (32) configured to be disposed about the locking pin or pin bearing between at the least one knuckle of the door leaf and the at least one knuckle of the jamb or frame leaf so as to raise or lower a relative height of the door leaf with respect to the jamb or frame leaf.

9. The Adjustable hinge (10) of claim 8, further comprising (C) squareness adjustment holes (26) in the jamb or frame leaf configured to receive jamb or frame leaf spacers or shim buttons (28) for adjusting a relative position of the jamb or frame leaf inward or outward with respect to door jamb so as to adjust the jamb or frame leaf squareness with the door jamb and independently of the pivot connection.

10. The Adjustable hinge (10) of claim 8, further comprising (B) elongated slots (30) in the door leaf configured for receiving second fastener parts for attaching the door leaf to an edge of the door and for moving the door along the elongated slots to adjust a flushness position of the door relative to the jamb or frame leaf and independently of the pivot connection.

11. An adjustable hinge (10), comprising:
a jamb or frame leaf (12) including first holes (24) for receiving first fastening parts for mounting the jamb or frame leaf to a door jamb;
a door leaf (14) for mounting the adjustable hinge to a door;
the jamb or frame leaf and the door leaf each having at least one door leaf knuckle (18) configured to receive a locking pin or pin bearing (16) and roller thrust bearings (20) that form a pin connection so as to fix the door leaf and jamb or frame leaf against relative axial movement and to enable the door leaf and jamb or frame leaf to rotate relative to each other about a pivot axis (22) of the locking pin or pin bearing and at least one leaf knuckle connection; and
(B) elongated slots (30) in the door leaf configured for receiving second fastener parts for attaching the door leaf to an edge of the door and for moving the door along the elongated slots to adjust a flushness position of the door relative to the jamb or frame leaf and independently of the pivot connection.

12. The Adjustable hinge (10) of claim 11, further comprising (C) squareness adjustment holes (26) in the jamb or frame leaf configured to receive jamb or frame leaf spacers or shim buttons (28) for adjusting a relative position of the jamb or frame leaf inward or outward with respect to door jamb so as to adjust the jamb or frame leaf squareness with the door jamb and independently of the pivot connection.

13. The Adjustable hinge (10) of claim 11, further comprising (A) height adjustment spacers (32) configured to be disposed about the locking pin or pin bearing between at the least one knuckle of the door leaf and the at least one knuckle of the jamb or frame leaf so as to raise or lower a relative height of the door leaf with respect to the jamb or frame leaf.

14. An adjustable hinge (10), comprising:
a jamb or frame leaf (12) including first holes (24) for receiving first fastening parts for mounting the jamb or frame leaf to a door jamb;
a door leaf (14) for mounting the adjustable hinge to a door;
the jamb or frame leaf and the door leaf each having at least one door leaf knuckle (18) configured to receive a locking pin or pin bearing (16) and roller thrust bearings (20) that form a pin connection so as to fix the door leaf and jamb or frame leaf against relative axial movement and to enable the door leaf and jamb or frame leaf to rotate relative to each other about a pivot axis (22) of the locking pin or pin bearing and at least one leaf knuckle connection; and
(C) squareness adjustment holes (26) in the jamb or frame leaf configured to receive jamb or frame leaf spacers or shim buttons (28) for adjusting a relative position of the jamb or frame leaf inward or outward with respect to door jamb so as to adjust the jamb or frame leaf squareness with the door jamb and independently of the pivot connection.

15. The Adjustable hinge (10) of claim 14, further comprising (B) elongated slots (30) in the door leaf configured for receiving second fastener parts for attaching the door leaf to an edge of the door and for moving the door along the elongated slots to adjust a flushness position of the door relative to the jamb or frame leaf and independently of the pivot connection.

16. The Adjustable hinge (10) of claim 14, further comprising (A) height adjustment spacers (32) configured to be disposed about the locking pin or pin bearing between at the least one knuckle of the door leaf and the at least one knuckle of the jamb or frame leaf so as to raise or lower a relative height of the door leaf with respect to the jamb or frame leaf.
